(19) United States
(12) Patent Application Publication
(10) Pub. No.: US 2026/0077362 A1
(43) Pub. Date: Mar. 19, 2026

(54) MATERIAL RECOVERY SYSTEM FOR WET ASH GENERATED FROM MUNICIPAL WASTE COMBUSTION

(71) Applicant: Reworld Waste, LLC, Morristown, NJ (US)

(72) Inventors: Timothy Miller, Mechanicsburg, PA (US); Rebecca Guardino, Montville, NJ (US); Ainsworth James, Clifton, NJ (US); Anthony Dell’Anno, East Falmouth, MA (US); Abdurrahman Khalidi, Niskayuna, NY (US); Steven Bossotti, Bridgewater, NJ (US); John Davis, Morristown, NJ (US)

(21) Appl. No.: 19/328,778

(22) Filed: Sep. 15, 2025

Related U.S. Application Data
(60) Provisional application No. 63/694,518, filed on Sep. 13, 2024.

(51) Int. Cl. B03C 1/30; B03B 9/04; B03C 1/16; B03C 1/23

(52) U.S. Cl. CPC B03C 1/30; B03B 9/04; B03C 1/16; B03C 1/23; B03C 2201/20

(57) ABSTRACT

A material recovery system for wet ash generated from municipal waste includes infeed storage of wet ash, an oversized and organic removal subsystem, a material sizing subsystem, a metal recovery subsystem, and an aggregate finishing subsystem. The system for material recovery results in the output of commercially usable aggregate material, ferrous materials, and non-ferrous materials. The subsystems of the material recovery system include one or more screens, dryers, feed hoppers, eddy current separators, magnets, crushers, and air classifiers.

### CROSS REFERENCE TO RELATED APPLICATION

This application claims priority to U.S. Provisional Application No. 63/694,518, filed Sep. 13, 2024, the contents of which are hereby incorporated by reference in its entirety.

### BACKGROUND

### 1. Field of Disclosure

Embodiments of the present disclosure relate to a wet ash processing system to produce aggregate and recover ferrous and non-ferrous metals from ash generated by a municipal waste combustion process.

### 2. Description of Related Art

Millions of tons of solid waste are disposed of in landfills each year. As an alternative to new landfills and/or to increase the time life span of existing landfills, Municipal Waste Combustor (MWC) plants incinerate solid waste, potentially reducing the mass of material disposed by 80% and the volume of material disposed by potentially 90%. At MWC plants, after municipal solid waste is processed through combustion, ash residue remains, which may be fly ash and bottom ash. MWCs may also generate renewable energy, which has a net-negative carbon footprint. Some MWC plants do metal recovery from the ash residue, which is sometimes performed using magnets and/or eddy currents.

### SUMMARY

Applicant recognized the problems noted above herein and conceived and developed embodiments of systems, according to the present disclosure, for processing wet ash generated from municipal waste combustion to recover aggregate and metal.

In an embodiment, an ash processing system includes one or more screens for separating first particles of ash having a first diameter less than a first threshold from second particles of the ash having a second diameter greater than the first threshold, one or more magnets for removing ferrous metals from the ash, one or more eddy current separators for removing non-ferrous metals from the ash, one or more magnetic belt separators for removing magnetic solids from the ash, one or more air density separators for separating light non-ferrous metals of the non-ferrous metals from heavy non-ferrous metals of the non-ferrous metals, and an aggregate wash plant for producing finished aggregate comprising non-metal particulate matter.

In another embodiment, an ash processing system includes an oversized and organic removal subsystem and a material sizing subsystem. The oversized and organic removal subsystem includes one or more primary screens configured to separate first particles of the ash having a first diameter less than a predetermined diameter value from second particles of the ash having a second diameter greater than the predetermined diameter value, one or more first magnets configured to separate out ferrous metals from the ash, and an air classifier configured to remove light debris or organic material from the ash. The material sizing subsystem includes one or more secondary screens, one or more magnetic belt separators configured to remove magnetic solids from the ash, one or more first eddy current separators configured to recover non-ferrous metals, a crusher configured to reduce a particle size of the ash to a desired size, one or more second magnets configured to recover post-crush ferrous metals after the particle size reduction in the crusher, and one or more second eddy current separators configured to recover liberated non-ferrous metal upon the particle size reduction in the crusher.

In another embodiment, a metal recovery system includes a multi-deck screen to separate ash into a first size fraction, a second size fraction, and a third size fraction, a first eddy current separator, a second eddy current separator, a third eddy current separator, a first magnetic belt separator for recovering first magnetic solids from the first size fraction and conveying first non-magnetic solids to the first eddy current separator, wherein the first eddy current separator recovers non-ferrous metals from the first non-magnetic solids, a second magnetic belt separator for recovering second magnetic solids from the second size fraction and conveying second non-magnetic solids to the second eddy current separator, wherein the second eddy current separator recovers the non-ferrous metals from the second non-magnetic solids, and a third magnetic belt separator for recovering third magnetic solids from the third size fraction and conveying third non-magnetic solids to the third eddy current separator, wherein the third eddy current separator recovers the non-ferrous metals from the third non-magnetic solids. In the metal recovery system, the non-ferrous metals are fed to one or more air density separator tables for separating light non-ferrous metals from heavy non-ferrous metals.

### BRIEF DESCRIPTION OF DRAWINGS

The present technology will be better understood on reading the following detailed description of non-limiting embodiments thereof, and on examining the accompanying drawings, in which:

FIG. 1 is an overview schematic diagram of an embodiment of an ash processing system, in accordance with embodiments of the present disclosure;

FIG. 2 is a process flow diagram of an embodiment of a bulky and organic removal system, in accordance with embodiments of the present disclosure;

FIG. 3 is a process flow diagram of an embodiment of a material sizing system, in accordance with embodiments of the present disclosure;

FIG. 4 is a process flow diagram of an embodiment of a metal recovery system, in accordance with embodiments of the present disclosure; and

FIG. 5 is a process flow diagram of an embodiment of an aggregate finishing system, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Like numbers may be used to refer to like elements throughout, but it should be appreciated that using like numbers is for convenience and clarity and not intended to limit embodiments of the present disclosure. Moreover, references to “substantially” or “approximately” or “about” may refer to differences within ranges of +/−10 percent.

In terms of the present disclosure, nominal size variations are provided based on the processing of ash residue from mass-burn Municipal Waste Combustor (MWC) facilities. Variations from these operating parameters may be necessary based on the physical properties of the ash or waste being processed, moisture variability in the ash being processed, or seasonal changes in local operating conditions. These variations would fall within the scope of the present disclosure.

Embodiments of the present disclosure are directed to systems and methods for separating ash residue from MWCs (which may be fly ash, bottom ash, or a combination thereof) into multiple streams for the purposes of maximizing metal (ferrous and non-ferrous) recovery, and processing the residual streams after metal recovery, for the purpose of producing commercially usable aggregate and/or sand products (i.e., an aggregate and sand combination, only aggregate, or only sand). The systems and methods described herein are directed to the separation of MWC ash residue for the purpose of recovery of ferrous and non-ferrous metals, and for the generation of commercially usable aggregate and/or sand. The systems and methods may improve metal recovery value (quantity and quality) of the ash processed, improve the yield of aggregate and/or sand from the ash processed, and reduce the amount of waste generated in the process, which would ultimately require landfill disposal.

Embodiments of the present disclosure are also directed toward a system and method of producing aggregate and recovering metals generated by MWC processes. More specifically, the systems and methods may be composed of four major subsystems: (1) an initial oversized and organic removal subsystem, which may include: a primary bulky removal screen, a primary magnet to remove ferrous metals, a primary sizing screen, a secondary magnet to remove additional ferrous metals, an air classifier system to remove light debris, and/or a network of transport conveyors; (2) a material sizing subsystem, which may include: sizing screens or other methods of size separation, one or more crushers for particle size reduction, magnets, eddy current separators (ECSs) for coarse metal recovery, a network of transport conveyors, and/or a dryer to remove moisture from the material; (3) a metal recovery subsystem for the removal of aluminum and heavy metals, which may include: magnets or magnetic belt separators, ECSs, air density separation systems, and/or a network of transport conveyors; and (4) an aggregate finishing subsystem to remove, via air or washing, any remaining organics or lightweight particles from the finished aggregate.

Embodiments of the oversized and organic removal system may remove oversized materials, remove light debris and inert materials, and/or remove a portion of the fly ash. Embodiments of the material sizing system may include crushing oversized material to capture encapsulated metal and to obtain a targeted aggregate size. Embodiments of the metal recovery system may include drying of the material prior to eddy current separation. The process may also include mill resizing of the usable aggregate and/or sand. Embodiments of the aggregate finishing process may remove any residual organics or fines in the aggregate.

Systems and methods of the present disclosure may address and overcome problems with existing approaches to metal removal from waste streams. For example, while magnets and eddy currents may recover some metal, conventional approaches may leave behind or otherwise be incapable of extracting quantities of remaining metal remaining in the ash. One or more embodiments of the present disclosure provide systems and methods for sustainably reducing the disposal needs of MWCs by both improving resource (ferrous and non-ferrous metal) recovery from the ash, and by producing aggregate, sand, or a combination thereof, which may have commercial reuse applications. Embodiments of the present disclosure may include higher metal recovery compared to conventional approaches, further processing of the ash to create a usable aggregate with commercial value, and less leftover excess materials going to landfills.

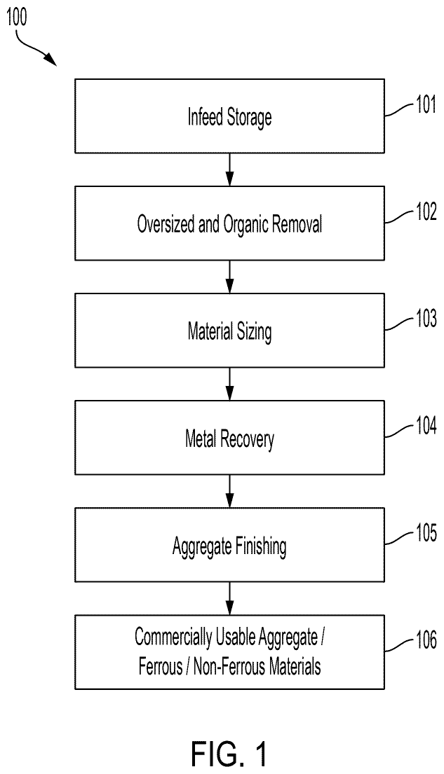

FIG. 1 illustrates an overview of an embodiment of an ash processing system 100 that may be used for material recovery from wet ash generated from municipal waste combustion. Ash may be delivered to the processing site where it is stored in an in-feed materials storage area 101 (e.g. a “storage area”). The moisture content of the wet ash may vary. Wet ash may have, for example, 18-24% moisture composition, although the moisture content could, for example, be higher in the winter and lower in the summer. The in-feed storage area 101 may have a non-permeable or semi-permeable floor, such as concrete or asphalt, and may be a covered facility or area. Sufficient storage volume allows for a residence time for the ash to dry naturally prior to processing.

From the storage area 101, the ash is fed into an oversized and organic removal system 102 using an excavator, front end loader, or any other equipment configured for bulk-loading to feed the oversized and organic removal system 102. The oversized and organic removal system 102 may provide for removal of bulky materials, primary and secondary ferrous metal recovery, and air classification for the removal of paper and other light undesirable debris. In other embodiments, the oversized and organic removal system 102 may provide for non-ferrous removal from the large ash fractions, crushing of the large ash fraction, removal of residual magnetic material, removal of fines via mechanical mechanism (utilized when processing combined ash for the removal of as much of the fly ash component as possible), and conveying equipment to a material sizing system 103.

The material sizing system 103 may provide for size separation of materials via screening or other methods. Metal recovery on the coarse fraction of the materials may take place prior to size reduction via crushing. Once materials meet a desired size or desired size range, the material sizing system 103 may include a dryer for moisture reduction prior to introduction to the metal recovery system 104. In an embodiment, the processing dryers may be in-line processing dryers designed to yield a specific moisture content range of the product before further dry separation occurs. For example, the specific moisture content range of the product may be about 10 wt% to about 6 wt%.

The metal recovery system 104 may include one or more magnetic separation belts, one or more ECSs, and/or one or more density separators. The ash processing system 100 may further include an aggregate finishing system 105 that may contain an air classifier and an aggregate washing plant, resulting in the final aggregate product to be stored until it can be shipped for commercial reuse.

From each subsystem of the ash processing system 100 of FIG. 1, there are various output materials that are produced. From the in-feed system 101, stored raw bottom ash or combined ash is produced. From the oversized and organic removal system 102, one or more of the following may be produced: screened bulky materials for further recovery or disposal, recovered ferrous metal, paper and light debris waste, and/or ash for use as material sizing system 103 feedstock. The material sizing system 103 may produce one or more of the following: magnetic solid material, sand, coarse recovered non-ferrous metal, fine ash material for disposal, ferrous metal recovered after crushing, and/or ash/aggregate/metal material to be used as feed to the metal recovery system 104. The metal recovery system 104 may produce: magnetic solids, light non-ferrous metal (e.g., aluminum) and heavy non-ferrous metal (e.g., copper, brass, zinc, etc.) of various sizes, and/or non-metallic material to be used as feed to the aggregate finishing system 105. Light non-ferrous metals may be defined as having relatively lower density (e.g., density below about 5 g/cm³) and heavy non-ferrous metals may be defined as having relatively higher density (e.g., density above about 5 g/cm³). Finally, the aggregate finishing system 105 may produce one or more of the following: paper and light debris waste and/or finished aggregate. In an embodiment, the recovered light non-ferrous metal, such as aluminum, may be about 0 mm to about 4 mm in size. In another embodiment, the recovered aluminum may be about 4 mm to about 12 mm. In an embodiment, it should be appreciated that the recovered aluminum, heavy non-ferrous metal, and/or aggregate may be any reasonable size depending on market demand and/or equipment constraints of the ash processing system 100.

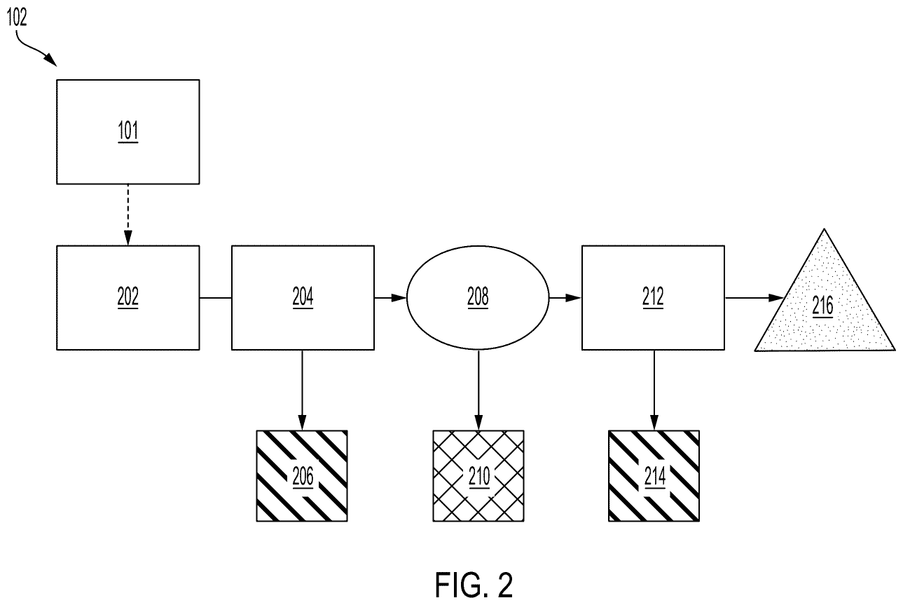

FIG. 2 illustrates the features of an embodiment of an oversized and organic removal system 102. The arrows between elements of the system in this FIG. 2 and the other figures displayed in the drawings, may indicate that the applicable material is conveyed, transported, or otherwise moved from one feature to another. The oversized and organic removal system 102 may begin with a feed hopper 202. MWC ash is fed into the feed hopper 202 by means of an excavator, or other equivalent means. At the bottom of the feed hopper 202, there may be a feed conveyor, which feeds a primary bulky screen 204 (e.g. a “bulky screen”). It should be appreciated that although there is only one bulky screen 204 depicted in FIG. 1, there may be two bulky screens 204, three bulky screens 204, or any reasonable number of bulky screens 204, depending on the embodiment. The primary bulky screen 204 may be a perforated plate, a conventional shaker screen, or utilize any other oscillating technology. The primary bulky screen 204 may remove, or “scalp” the oversized, bulky, or unburned items 206 that are present in a mass-burn MWC bottom ash or combined ash stream. The primary bulky screen 204 may remove items 206 with a diameter of a certain size or larger. For example, primary bulky screen 204 may remove items 206 with a diameter of 50 mm or larger. However, it should be appreciated that the primary bulky screen 204 may also be configured to remove items 206 at or above any reasonable diameter, depending on desired system design. The stream of material larger than the screen size is inspected and evaluated either for further ferrous recovery or disposed of as a waste (e.g. “bulky discards”).

The ash that falls through the primary bulky screen 204 (for example, ash with diameter between about 0 mm and about 50 mm) is conveyed to a primary magnet 208 for recovery of ferrous material 210, and then to an air classifier 212 to remove organics 214. Organic material 214 may be paper, plastic, rags, etc., which is considered waste and may be disposed. The remaining ash after the oversized and organic removal system 102, now free of oversized and organic particles may be conveyed to a “work in progress” stockpile 216 or it may be conveyed directly to the material sizing system 103.

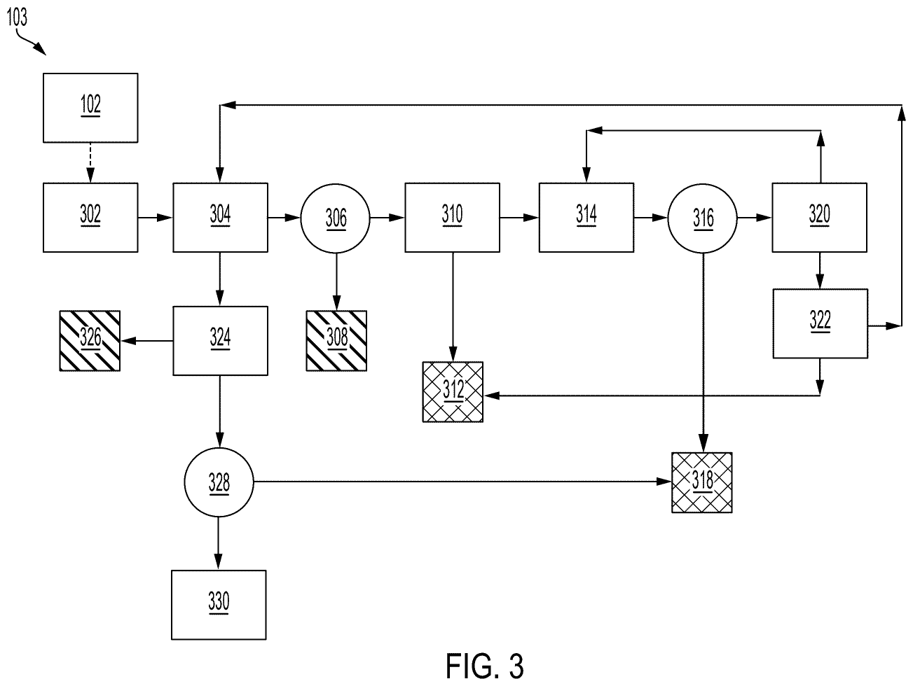

The material sizing system 103, illustrated in FIG. 3, may be fed in-line from the oversized and organic removal system 102 or fed into a feed hopper 302 via front end loader or equivalent. The one or more first secondary screens 304 may use an oscillating, or “flip flow,” technology to size the material into a large fraction (for example, diameter between about 0 mm and about 50 mm), and to pass the material nominally no larger than the largest desired aggregate size. The flip flow technology, if implemented, is a screen that makes the material flip over as it moves through and along the screen, such that larger particles are filtered out and the finer or smaller materials are separated through the one or more first secondary screens 304.

The large fraction that passes through the one or more first secondary screens 304 may be presented to a magnetic belt separator 306. The magnetic belt separator 306 may use a continuously moving belt (similar to a conveyor system) with embedded magnets to remove magnetic solids 308 from bulk materials as they pass through a processing line. Remaining non-magnetic solids after the magnetic belt separator 306 may be conveyed to a first ECS 310 for the removal of non-ferrous metals 312. Although only one first ECS 310 is depicted in FIG. 3, there may be any reasonable number of ECSs 310 implemented into the material sizing system 103. The rejects from the first ECS 310 may be directed to an inline crusher 314 (e.g. a “crusher”) or stored in off-line bunkers until the material can be fed to the crusher 314. The crusher 314 may reduce the remainder of material down to a size no larger than the desired aggregate size (e.g., about 12 mm diameter) and release or liberate encapsulated metals in the stream. In other words, before the stream of material enters the crusher, there may be metal present in the stream, but the metal is fully encapsulated by non-metal substances such that magnets, magnetic belt separators, and ECSs were unable to remove the encapsulated metal from the stream of material. Upon crushing the encapsulated metal, the metal may be liberated from its encapsulation such that magnets, magnetic belt separators, or ECSs may be able to recover the newly liberated metal from the stream. A magnet 316 may be included in the material sizing system 103 to recover any ferrous metal 318 that is liberated during the crushing process of the crusher 314. The crushed material is then directed to size separation 320 (e.g., screens) to remove any particles still larger than the desired size. The particles still larger than the desired size may be recirculated back to the crusher 314 for further particle size reduction. Crushed material that passes through the size separation 320 may be sent to a second ECS 322 for additional recovery of non-ferrous metal 312. It should be appreciated that although only one second ECS 322 is depicted in FIG. 3, any reasonably number of ECSs 322 may be implemented in the material sizing system 103. Furthermore, in one or more embodiments, the crushed material that passes through the size separation 320 may be sent back to the first ECS 310. The rejects from the ECS 322 may be sent back to the one or more first secondary screens 304 for further size separation.

The ash that passes the one or more first secondary screens 304 (i.e., the ash that is fine enough to pass through the one or more first secondary screens 304) may be conveyed to one or more second secondary screens 324 (e.g., additional size separators) for removal of the fine ash fraction 326 (e.g., “fly ash”). The one or more second secondary screens 324 may use an oscillating technology to sift out particles smaller than the smallest acceptable size to meet system performance objectives. The optimal size is chosen from system performance measurement and operational knowledge. The material that passes the one or more second secondary screens 324 may be waste ash 326, which may be left for further processing or discarded as waste depending upon the material quality. The material qualities assessed may include, for example, presence of metals including precious metals, overall composition of the material, and/or whether it appears further filtering and segregation could improve material quality. The waste ash 326 that does not pass the one or more second secondary screens 324 may be sent to an additional magnet 328 for further ferrous metal recovery 318 and then may be sent to a dryer 330 for moisture removal. The desired moisture content for presentation to the metal recovery system 104 may be less than 8%.

Ash resulting from the material sizing system 103 may further be conveyed to a stockpile before being fed into the metal sizing system 104. However, in other embodiments, this ash that does not pass the one or more second secondary screens 324 may also enter an in-line system with a surge bin, instead of diverting the ash to a stockpile.

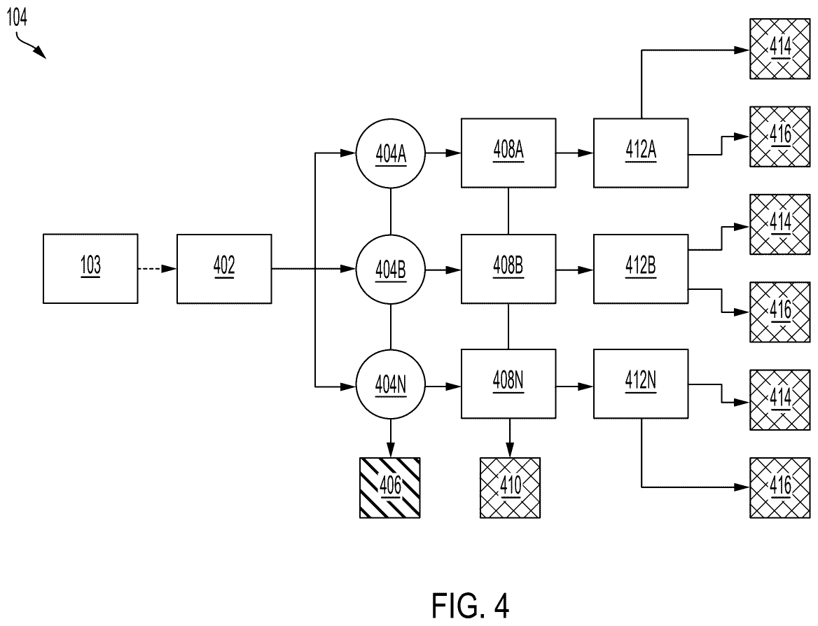

FIG. 4 illustrates the features of an exemplary metal recovery system 104. The metal recovery system 104 includes a multi-deck screen 402 to separate the ash into several size fractions for optimized metal recovery. Once the ash is separated into the several size fractions, the ash is presented to one or more magnetic belt separators 404A-404N to separate out and collect magnetic solids 406. Ash remaining after the one or more magnetic belt separators 404A-404N remove magnetic solids 406 is then presented to and processed over one or more ECSs 408A-408N to recover non-ferrous metals from the ash. What is not recovered as non-ferrous metals from the one or more ECSs 408A-408N is rejected non-metals 410. As can be seen in FIG. 4, each of the one or more magnetic belt separators 404A-404N may feed an associated ECS 408A-408N of the one or more ECSs 408A-408N. However, it should be appreciated that there may be more magnetic belt separator 404A-404N than ECSs 408A-408N and/or there may be more ECSs 408A-408N than magnetic belt separators 404A-404N. Accordingly, a single magnetic belt separator may provide feed to multiple ECSs. Similarly, a single ECS may receive feed from multiple magnetic belt separators. The rejected non-metal 410 from the one or more ECSs 408A-408N may be sent on to the aggregate finishing system 105.

The recovered non-ferrous metal from the ECSs 408A-408N may be sent to one or more air density separator tables 412A-412N or similar technology. As can also be seen in FIG. 4, each of the one or more ECSs 408A-408N may feed an associated air density separator table 412A-408N of the one or more air density separator tables 412. However, it should be appreciated that there may be more air density separator tables 412A-412N than ECSs 408A-408N and/or there may be more ECSs 408A-408N than air density separator tables 412A-412N. Accordingly, a single ECS may provide feed to multiple air density separator tables. Similarly, a single air density separator table may receive feed from multiple ECSs. Each of the one or more air density separator tables may separate light metals 414 (e.g., aluminum) from heavy non-ferrous metals 416 (e.g., copper, brass, zinc). Each of the light metals 414 collected from the one or more air density separator tables 412 may be consolidated, and each of the heavy non-ferrous metals 416 collected from the one or more air density separator tables 412 may also be consolidated.

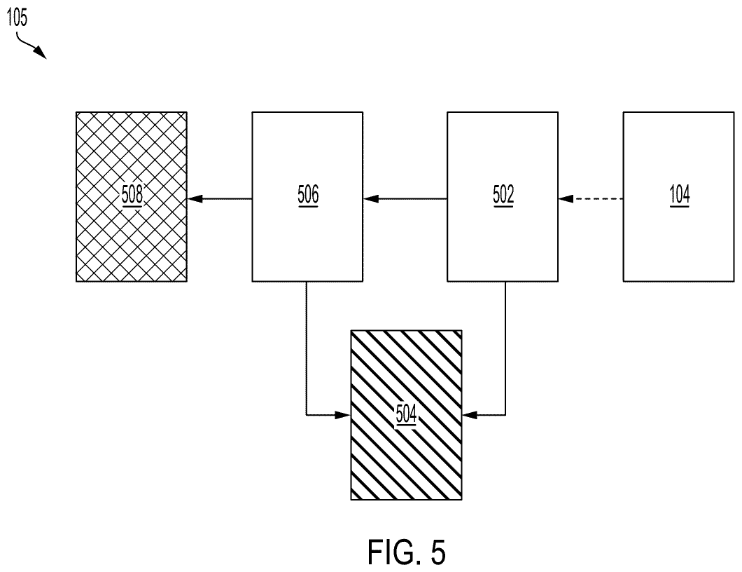

FIG. 5 illustrates the features of an exemplary aggregate finishing system 105. In the aggregate finishing system 105, the sized, unfinished aggregate, once suitably dry, may be fed into an air classifier 502 to remove any final organic material 504 prior to washing in an aggregate wash plant 506. The sized, unfinished aggregate is washed in the aggregate wash plant 506 to remove any particles finer than about 0.075 mm, as one non-limiting example, and ultimately produce finished aggregate 508. The finished aggregate 508 may be comprised of particles of stone, glass, ceramic, brick, slag, and/or other materials present in the waste stream. This finished aggregate 508 may be encapsulated and used as a raw material in building products such as concrete or asphalt. In other embodiments, the finished aggregate 508 may further be crushed down to create a manufactured sand.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. An ash processing system, comprising:
one or more screens for separating first particles of ash having a first diameter less than a first threshold from second particles of the ash having a second diameter greater than the first threshold;
one or more magnets for removing ferrous metals from the ash;
one or more eddy current separators for removing non-ferrous metals from the ash;
one or more magnetic belt separators for removing magnetic solids from the ash;
one or more air density separators for separating light non-ferrous metals of the non-ferrous metals from heavy non-ferrous metals of the non-ferrous metals; and
an aggregate wash plant for producing finished aggregate comprising non-metal particulate matter.

2. The ash processing system of claim 1, further comprising:
a dryer for removing moisture from the ash.

3. The ash processing system of claim 1, further comprising:
a crusher for reducing particle size of the ash to at least a target size.

4. The ash processing system of claim 1, further comprising:
one or more secondary screens for separating third particles of the ash having a third diameter less than a second threshold from fourth particles of the ash having a fourth diameter greater than the second threshold.

5. The ash processing system of claim 4, wherein the one or more secondary screens remove fly ash from the ash.

6. The ash processing system of claim 4, wherein the one or more secondary screens are oscillating screens.

7. The ash processing system of claim 1, further comprising:
one or more air classifiers for removing light debris or organic material from the ash.

8. The ash processing system of claim 1, wherein the light non-ferrous metals comprise aluminum.

9. The ash processing system of claim 1, wherein the heavy non-ferrous metals comprise at least one of copper, brass, or zinc.

10. The ash processing system of claim 1, further comprising:
a multi-deck screen for separating the ash into one or more size fractions.

11. The ash processing system of claim 1, further comprising:
a feed hopper for storing the ash.

12. An ash processing system, comprising:
an oversized and organic removal subsystem, comprising:
one or more primary screens configured to separate first particles of the ash having a first diameter less than a predetermined diameter value from second particles of the ash having a second diameter greater than the predetermined diameter value;
one or more first magnets configured to separate out ferrous metals from the ash; and
an air classifier configured to remove light debris or organic material from the ash; and
a material sizing subsystem, comprising:
one or more secondary screens;
one or more magnetic belt separators configured to remove magnetic solids from the ash;
one or more first eddy current separators configured to recover non-ferrous metals;
a crusher configured to reduce a particle size of the ash to a desired size;
one or more second magnets configured to recover post-crush ferrous metals after the particle size reduction in the crusher; and
one or more second eddy current separators configured to recover liberated non-ferrous metal upon the particle size reduction in the crusher.

13. The ash processing system of claim 12, wherein ash that does not pass through the one or more secondary screens is recirculated back to the crusher for further crushing.

14. The ash processing system of claim 12, further comprising:
a feed hopper configured to store the ash.

15. The ash processing system of claim 12, further comprising:
a dryer configured to remove moisture from the ash.

16. The ash processing system of claim 12, wherein the one or more secondary screens are configured to remove fly ash from the ash.

17. The ash processing system of claim 12, wherein the one or more secondary screens are oscillating screens.

18. A metal recovery system, comprising:
a multi-deck screen to separate ash into a first size fraction, a second size fraction, and a third size fraction;
a first eddy current separator;
a second eddy current separator;
a third eddy current separator;
a first magnetic belt separator for recovering first magnetic solids from the first size fraction and conveying first non-magnetic solids to the first eddy current separator, wherein the first eddy current separator recovers non-ferrous metals from the first non-magnetic solids;
a second magnetic belt separator for recovering second magnetic solids from the second size fraction and conveying second non-magnetic solids to the second eddy current separator, wherein the second eddy current separator recovers the non-ferrous metals from the second non-magnetic solids; and
a third magnetic belt separator for recovering third magnetic solids from the third size fraction and conveying third non-magnetic solids to the third eddy current separator, wherein the third eddy current separator recovers the non-ferrous metals from the third non-magnetic solids;
wherein the non-ferrous metals are fed to one or more air density separator tables for separating light non-ferrous metals from heavy non-ferrous metals.

19. The metal recovery system of claim 18, wherein the light non-ferrous metals comprise aluminum.

20. The metal recovery system of claim 18, wherein the heavy non-ferrous metals comprise at least one of copper, brass, or zinc.
